(19) United States
(12) Patent Application Publication
(10) Pub. No.: US 2022/0093990 A1
(43) Pub. Date: Mar. 24, 2022

(54) CELL COOLING BODY, ELECTRIC STORAGE MODULE, AND VEHICLE

(71) Applicant: HONDA MOTOR CO.,LTD., Tokyo (JP)

(72) Inventor: Atsushi SAKURAI, Saitama (JP)

(21) Appl. No.: 17/458,550

(22) Filed: Aug. 27, 2021

(30) Foreign Application Priority Data
Sep. 24, 2020 (JP) 2020-159574

(51) Int. Cl. H01M 10/6555; H01M 10/613; H01M 10/625; H01M 50/204; H01M 50/249

(52) U.S. Cl. CPC H01M 10/6555; H01M 10/613; H01M 2220/20; H01M 50/204; H01M 50/249; H01M 10/625

(57) ABSTRACT

A cell cooling body includes a cell housing body housing a plurality of electric storage cells, the cell housing body including a first end plate and a second end plate, and two side plates coupling the first end plate and the second end plate and being placed opposite to each other, an insulation plate, and a cooling unit arranged between the plurality of electric storage cells, in which the cooling unit includes a cooling plate having a variable thickness and a frame body integrated with the cooling plate, and the cooling plate has an internal space and has one or more protrusions protruding towards the internal space.

The contents of the following Japanese patent application are incorporated herein by reference:

Japanese Patent Application NO. 2020-159574 filed on Sep. 24, 2020.

### BACKGROUND

### 1. Technical Field

The present invention relates to a cell cooling body, an electric storage module, and a vehicle.

### 2. Related Art

Patent document 1 describes an electric storage apparatus including a plurality of electric storage modules arranged in a row in one direction and a conductive plate that connects the mutual electric storage modules, the conductive plate being formed to be in an elastically deformable manner in the one direction. Patent document 2 describes that an electric storage cell is covered with a resin material, so that the electric storage cell is protected from impact or vibration. Patent document 3 describes a displacement absorption portion that absorbs expansion of an electric storage cell.

### CITATION LIST

### Patent Documents

[Patent document 1] Japanese Unexamined Patent Application, Publication No. 2019-216005

[Patent document 2] Japanese Unexamined Patent Application, Publication No. 2008-300692

[Patent document 3] Japanese Patent No. 6449108

### BRIEF DESCRIPTION OF THE DRAWINGS

FIG. 1 is a perspective view illustrating an external appearance of an electric storage module 80.

FIG. 2 is a front view illustrating the external appearance of the electric storage module 80.

FIG. 3 is an exploded perspective view of the electric storage module 80.

FIG. 4 is a perspective view illustrating an external appearance of a cell unit 60a.

FIG. 5 is an exploded perspective view of the cell unit 60a.

FIG. 6 is a perspective view of an external appearance of a cooling unit 50a.

FIG. 7 is an exploded perspective view of the cooling unit 50a.

FIG. 8 illustrates a side view of a cooling plate 100.

FIG. 9 illustrates force applied to the cooling plate 100.

FIG. 10 illustrates a block configuration of a vehicle 600 including the electric storage module 80.

### DESCRIPTION OF EXEMPLARY EMBODIMENTS

Hereinafter, the present invention will be described by way of embodiments of the invention, but the following embodiments are not intended to restrict the invention according to the claims. In addition, not all combinations of features described in the embodiments necessarily have to be essential to solving means of the invention.

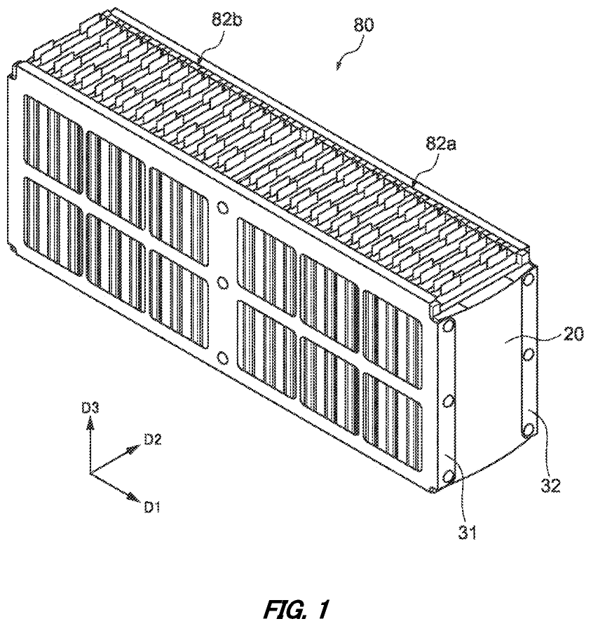

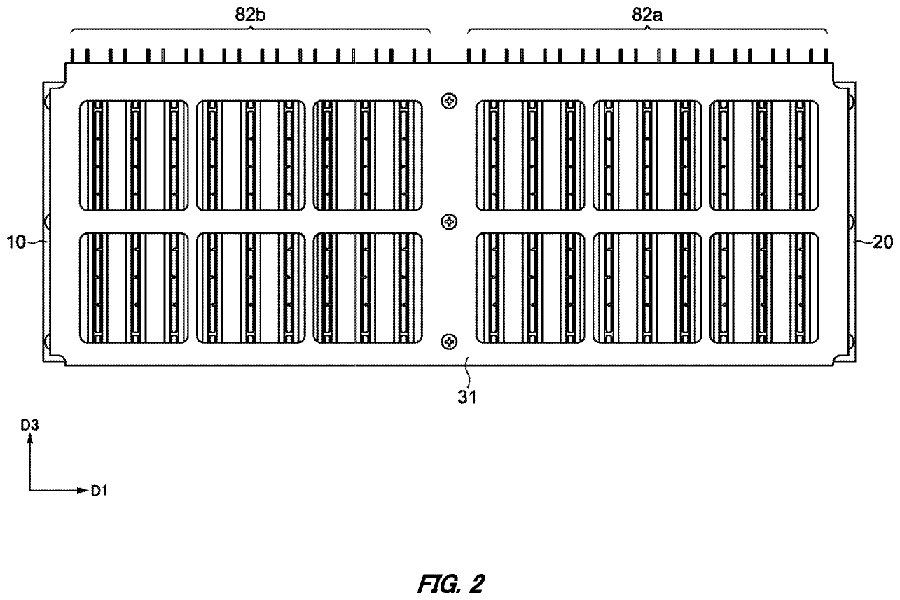

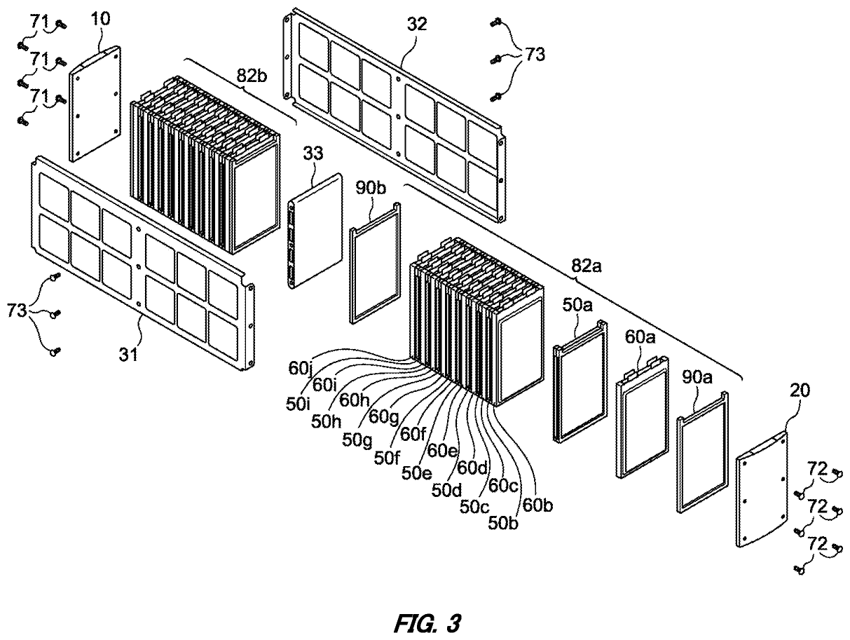

FIG. 1 is a perspective view illustrating an external appearance of an electric storage module 80. FIG. 2 is a front view illustrating the external appearance of the electric storage module 80. FIG. 3 is an exploded perspective view of the electric storage module 80.

According to the present embodiment, three directions D1, D2, and D3 are used when the electric storage module 80 is described. The D1 direction, the D2 direction, and the D3 direction are mutually orthogonal directions. For example, the D1 direction is a width direction of the electric storage module 80, the D2 direction is a depth direction of the electric storage module 80, and the D3 direction is a height direction of the electric storage module 80.

The electric storage module 80 has substantially a rectangular cylindrical shape. The electric storage module 80 includes a first end plate 10, a second end plate 20, a side plate 31, a side plate 32, an intermediate plate 33, a cell stack 82a, and an electric storage cell stack 82b.

The side plate 31 and the side plate 32 couple the first end plate 10 and the second end plate 20 and are placed opposite to each other. The cell stack 82a and the cell stack 82b are housed in a space surrounded by the first end plate 10, the second end plate 20, the side plate 31, and the side plate 32. The first end plate 10 and the second end plate 20, and the side plate 31 and the side plate 32 form at least a part of a cell housing body in which a plurality of electric storage cells are housed.

The first end plate 10 is attached to the side plate 31 and the side plate 32 by screws 71. The intermediate plate 33 is attached to the side plate 31 and the side plate 32 by screws 73. With this configuration, a first cell housing space surrounded by the second end plate 20, the intermediate plate 33, the side plate 31, and the side plate 32 is formed. The cell stack 82b is housed in the first cell housing space.

The second end plate 20 is attached to the side plate 31 and the side plate 32 by screws 72. With this configuration, a second cell housing space surrounded by the second end plate 20, the intermediate plate 33, the side plate 31, and the side plate 32 is formed. The cell stack 82a is housed in the second cell housing space.

In this manner, the intermediate plate 33 is arranged in the cell housing body to link the side plate 31 and the side plate 32 to form a plurality of cell housing spaces with the first end plate 10 and the second end plate 20.

The cell stack 82a includes an insulation plate 90a, a plurality of cell units 60a to 60j, a plurality of cooling units 50a to 50i, and an insulation plate 90b. The cell stack 82a has the same configuration as the cell stack 82b. For this reason, a detailed described of the cell stack 82a will be omitted.

In the cell stack 82a, the cell units 60a to 60j and the cooling units 50a to 50i are disposed between the insulation plate 90a and the insulation plate 90b along the D1 direction. With regard to the plurality of cell units 60a to 60j and the cooling units 50a to 50i, the cell units and the cooling units are alternately disposed along the D1 direction. Specifically, the cell unit 60j, the cooling unit 50i, the cell unit 60i, the cooling unit 50h, . . . , the cooling unit 50a, and the cell unit 60a are disposed along the D1 direction. The D1 direction is a stack direction of the cell stacks 82.

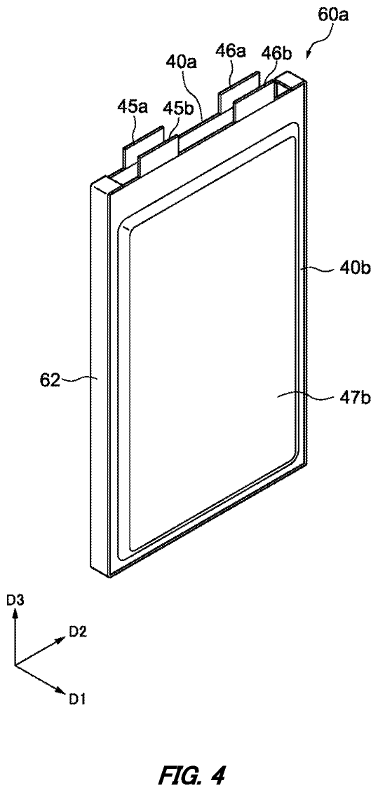

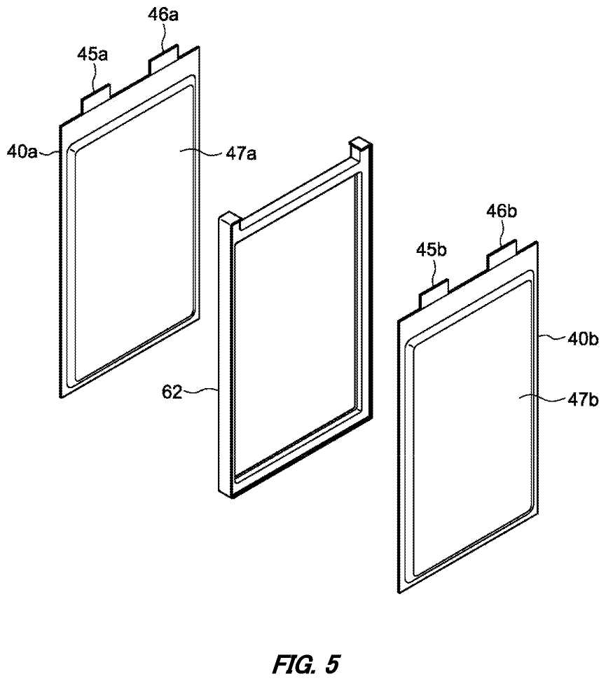

FIG. 4 is a perspective view illustrating an external appearance of the cell unit 60a. FIG. 5 is an exploded perspective view of the cell unit 60a. The cell units 60b to 60j have the same configuration as the cell unit 60a. For this reason, a detail description on the configuration of the cell units 60b to 60j will be omitted.

The cell unit 60a includes an electric storage cell 40a, an electric storage cell 40b, and a frame body 62. The electric storage cell 40a includes a terminal 45a, a terminal 46a, and a laminated film 47a. The terminal 45a is a positive terminal, and the terminal 46a is a negative terminal. The laminated film 47a contains therein an electrode stack body obtained by stacking a positive electrode and a negative electrode through an intermediary of a separator, and electrolyte. The positive electrode in the laminated film 47a is connected to the terminal 45a, and the negative electrode in the laminated film 47a is connected to the terminal 46a.

The electric storage cell 40b includes a terminal 45b, a terminal 46b, and a laminated film 47b. The terminal 45b is a positive terminal, and the terminal 46b is a negative terminal. The laminated film 47b contains therein an electrode stack body obtained by stacking a positive electrode and a negative electrode through an intermediary of a separator, and electrolyte. The positive electrode in the laminated film 47b is connected to the terminal 45b, and the negative electrode in the laminated film 47b is connected to the terminal 46b. The electric storage cell 40a may be a single battery cell of a lithium-ion battery.

The frame body 62 is disposed between the electric storage cell 40a and the electric storage cell 40b. The electric storage cell 40a, the frame body 62, and the electric storage cell 40b are disposed in the D1 direction. The D1 direction corresponds to a stack direction of a plurality of electric storage cells including the electric storage cell 40a and the electric storage cell 40b. When the cell unit 60a is assembled as the electric storage module 80, the frame body 62 is integrated with the electric storage cell 40a and the electric storage cell 40b. The frame body 62 may be made of resin.

When the frame body 62 is made of the resin, it is possible to avoid displacement of the electric storage cell 40a and the electric storage cell 40b. In addition, when the frame body 62 is made of the resin, formability is increased, and also a light weight is realized, which reduces costs. In addition, since the laminated film 47a and the laminated film 47b have a configuration where a resin layer is arranged over both sides of a metal layer and the metal layer is exposed from an end surface of the laminated film, when the frame body 62 is made of the resin, it is possible to suppress continuity of the metal layer on the end surface of a welded portion. Note that, for example, a welded portion of the laminated film 47a is formed in a circumferential portion of the electric storage cell 40a. The welded portion of the laminated film 47a is thinner than a thickness of the electrode stack body of a central portion. Similarly, a welded portion of the laminated film 47b is formed in the electric storage cell 40b. When the frame body 62 is disposed, a gap of the thin welded portion can be closed, so that cooling air hardly flows in the welded portion of the electric storage cell 40a.

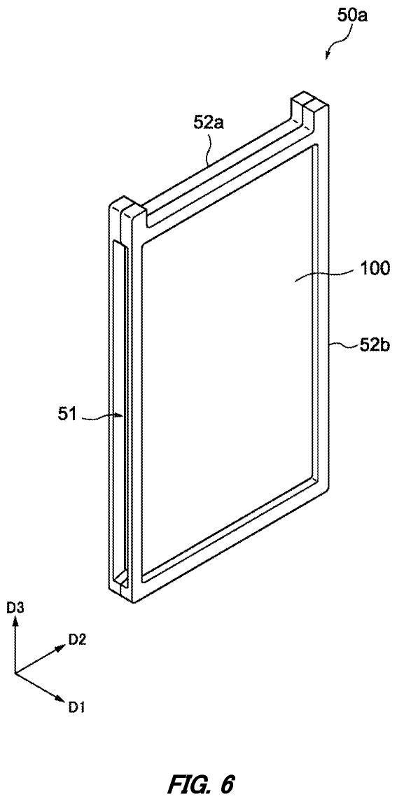

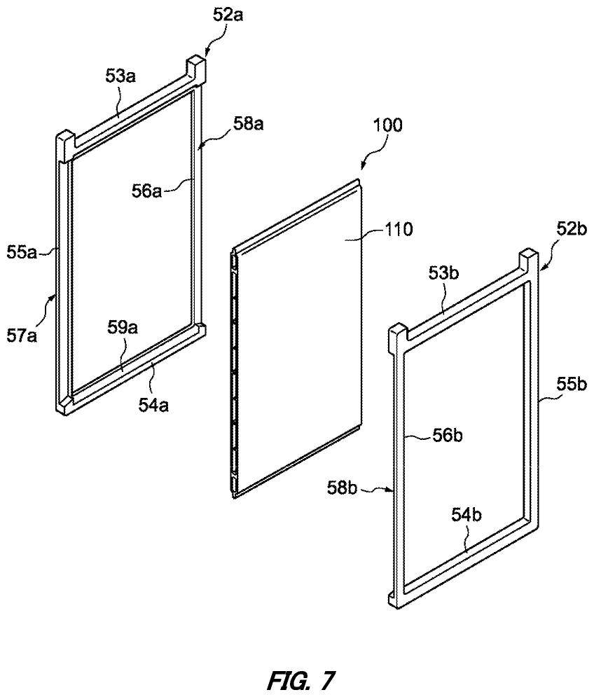

FIG. 6 is a perspective view illustrating an external appearance of the cooling unit 50a. FIG. 7 is an exploded perspective view of the cooling unit 50a. Cooling units 50b to 50i have the same configuration as the cooling unit 50a. For this reason, a detailed described of the configuration of the cooling units 50b to 50i will be omitted.

The cooling unit 50a includes a frame body 52a, a frame body 52b, and a cooling plate 100. The frame body 52a includes a side frame 55a, a side frame 56a, an end portion frame 53a, and an end portion frame 54a. The side frame 55a is located on a negative side of the D2 direction. The side frame 56a is located on a positive side of the D2 direction. The end portion frame 53a is located on a positive side of the D3 direction. The end portion frame 54a is located on a negative side of the D3 direction.

The frame body 52b includes a side frame 55b, a side frame 56b, an end portion frame 53b, and an end portion frame 54b. The side frame 55b is located on the positive side of the D2 direction. The side frame 56b is located on the negative side of the D2 direction. The end portion frame 53b is located on the positive side of the D3 direction. The end portion frame 54b is located on the negative side of the D3 direction. The frame body 52b has the same shape as the frame body 52a.

The cooling plate 100 is disposed between the frame body 52a and the frame body 52b. When the cooling unit 50a is assembled as the electric storage module 80, the frame body 52a and the frame body 52b are integrated with the cooling plate 100. Note that the frame body 52a and the frame body 52b are made of resin. The frame body 52a and the frame body 52b may be integrated by resin affixation. The frame body 52a and the frame body 52b may be integrated by insert molding, snap fit, or the like.

The side frame 55a has a recessed portion 57a, and the side frame 56a has a recessed portion 58a. Similarly, the side frame 56b has a recessed portion 58b, and the side frame 55b also has a recessed portion that is not illustrated in the drawing. The recessed portion 57a of the side frame 55a and the recessed portion 58b of the side frame 56b form an opening 51 through which a coolant such as cooling air circulates in the cooling unit 50. Similarly, the recessed portion 58a of the side frame 56a and the recessed portion of the side frame 55b form another opening through which the coolant circulates in the cooling unit 50.

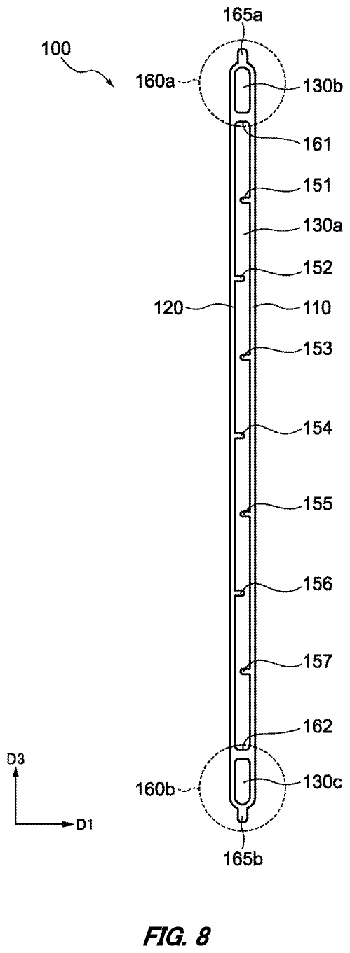

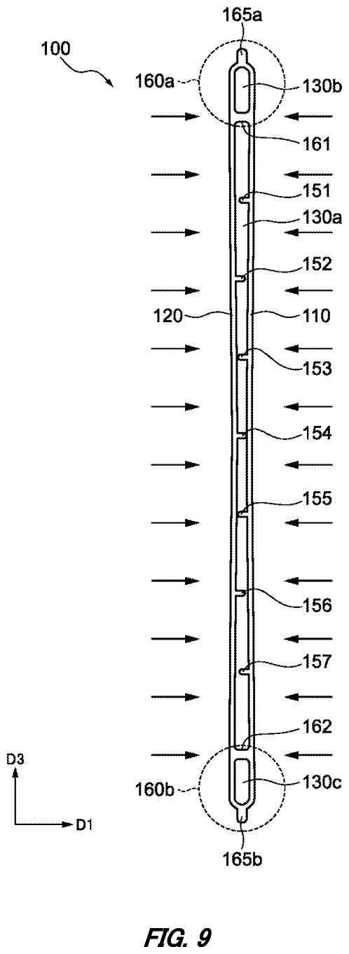

With further reference to FIG. 8 and FIG. 9, a structure of the cooling plate 100 will be described. FIG. 8 illustrates a side view of the cooling plate 100. Arrows in FIG. 9 indicate force applied to the cooling plate 100 by expansion of the electric storage cell or the like.

The cooling plate 100 includes a connection portion 160a, a connection portion 160b, a first plate portion 110, and a second plate portion 120. The cooling plate 100 has an internal space 130a, an internal space 130b, and an internal space 130c. The first plate portion 110 and the second plate portion 120 oppose to each other in the D1 direction. The internal spaces 130a to 130c are formed between the first plate portion 110 and the second plate portion 120. The cooling plate 100 includes a protrusion 151, a protrusion 152, a protrusion 153, a protrusion 154, a protrusion 155, a protrusion 156, and a protrusion 157 which protrude towards the internal space 130a. The internal spaces 130a to 130c are a space where the coolant circulates.

The cooling plate 100 has elasticity. For example, the first plate portion 110 and the second plate portion 120 have elasticity. The cooling plate 100 has a variable thickness. Note that the thickness of the cooling plate 100 is a length in the D1 direction. When force in the D1 direction is applied to the cooling plate 100, the thickness of the cooling plate 100 may be varied since the first plate portion 110 and the second plate portion 120 warp, for example.

When the electric storage module 80 is operated, the electric storage cells included in the cell units 60a to 60j may expand with age in the D1 direction. When the electric storage cells expand, the cooling plate 100 is pressed from both sides of the electric storage cells. For example, the first plate portion 110 is pressed in a D1 negative direction, and the second plate portion 120 is pressed in a D1 positive direction. When the cooling plate 100 is pressed from the electric storage cells on both sides, since the first plate portion 110 and the second plate portion 120 warp towards the internal space 130a, the load in the stack direction of the electric storage cells can be alleviated. In this manner, the load in the stack direction of the electric storage cells can be alleviated by the cooling unit 50. For this reason, as compared with a method of absorbing the expansion of the electric storage cells using another member such as a resin material, the structure of the electric storage module 80 can be simplified.

In addition, since the cooling plate 100 includes the protrusions 151 to 157 protruding in the internal space 130, cooling capacity is improved due to fin effectiveness. When the electric storage cells further expand, since the protrusions 151 to 157 come close to the facing cooling plate 100 or the second plate portion 120, the fin effectiveness can be increased, and a decrease in the cooling capacity at the time of cell degradation can be suppressed.

When the expansion of the electric storage cells progresses, the protrusions 151 to 157 may be in contact with the facing cooling plate 100 or the second plate portion 120. With this configuration, excessive deformation of the cooling plate 100 can be suppressed, and a necessity minimum area of a cooling passage can be secured.

The cooling plate 100 is made of metal. The cooling plate 100 assumes a role of absorbing expansion of an electrode body by contacting the laminated film that covers the electrode stack body of the adjacent electric storage cell. When a metallic cooling plate is used as the cooling plate 100, both the cooling capacity and strength can be satisfied. Note that the cooling plate 100 is formed by integral molding, and both ends of the internal space are sealed. For example, the cooling plate 100 may be integrally molded based on aluminum extraction. When the cooling plate 100 is formed by the integral molding, since spatial dimensions inside the cooling plate 100 are regulated, it is possible to suppress variation of the load and variation of the cooling capacity. Note that the cooling plate 100 may be configured by two plates, and both ends of the internal space may be formed by joining or close contact. For example, the cooling plate 100 may be formed by affixation of a plate member including the first plate portion 110 and a plate member including the second plate portion 120.

The protrusions 151 to 157 alternately protrude from the first plate portion 110 and the second plate portion 120 towards the internal space. For example, with regard to the protrusions 151 to 157, the protrusion 151, the protrusion 152, the protrusion 153, the protrusion 154, the protrusion 155, the protrusion 156, and the protrusion 157 are disposed in the stated order in the D3 negative direction. The protrusion 151, the protrusion 153, the protrusion 155, and the protrusion 157 protrude from the first plate portion 110 towards the internal space 130a, and the protrusion 152, the protrusion 154, and the protrusion 156 protrude from the second plate portion 120 towards the internal space. In this manner, since each of the first plate portion 110 and the second plate portion 120 includes the protrusions, even when the cooling plate 100 is pressed from both sides by the expansion of the electric storage cells, the excessive deformation can be suppressed. In addition, when the first plate portion 110 and the second plate portion 120 inwardly warp by the expansion of the electric storage cells, pressure loss relative to an identical flow rate is increased, but a flow velocity is increased. Therefore, the decrease in the cooling capacity at the identical flow rate can be suppressed.

Note that when the protrusions 151 to 157 protrude from at least one of the first plate portion 110 and the second plate portion 120 towards the internal space, an effect similar to the above-described effect can be attained. For example, when a mode in which protrusions are disposed on the first plate portion 110 is adopted, even when the cooling plate is pressed from both sides, the protrusions press the second plate portion 120 on the opposite side, so that the cooling passage can be secured, and the excessive deformation of the cooling plate itself can be suppressed.

The cooling plate 100 includes the connection portion 160a and the connection portion 160b which are connected to the frame body 52a and the frame body 52b. The connection portion 160a and the connection portion 160b are sites located at both ends of the internal space 130a. The connection portion 160a is in contact with at least the end portion frame 53a and the end portion frame 53b. The connection portion 160b is in contact with at least the end portion frame 54a and the end portion frame 54b. The connection portion 160a includes a protrusion portion 165a protruding in the D3 positive direction in a top portion. The connection portion 160b includes a protrusion portion 165b protruding in the D3 negative direction in a top portion. For example, the protrusion portion 165b is fitted in a groove formed by a groove portion 59a of the end portion frame 54a.

Since the cooling plate 100 includes the connection portion 160a and the connection portion 160b, the deformation of the end portions is suppressed against vibration input in the stack direction of the electric storage cells. With this configuration, overall movement of the electric storage cells is suppressed. In particular, since the displacement of the electric storage cells in the end portions in the stack direction of the electric storage cells is suppressed, it is facilitated to secure structural reliability of an electric connection portion such as a bus bar. In addition, since the first plate portion 110 and the second plate portion 120 function as an elastic member, while the movement in the stack direction of the end portions is suppressed by the connection portion 160a and the connection portion 160b, a dimensional tolerance in the stack direction at the time of the assembly can be absorbed by the first plate portion 110 and the second plate portion 120.

The cooling plate 100 includes, in both end portions connected to the frame body 52, an extension portion 161 and an extension portion 162 which extend in the D1 direction in the internal space formed by the first plate portion 110 and the second plate portion 120. With the extension portion 161 and the extension portion 162, it is possible to further suppress the deformation of the end portions with respect to the vibration input in the stack direction of the electric storage cells. In addition, it is possible to suppress the overall movement of the electric storage cells.

In accordance with the electric storage module 80 described above, it is facilitated to secure the coolant passage. For example, according to the configuration described in above-mentioned Patent document 1, it is not easy to secure the cooling passage when elastic deformation of a conductive plate occurs, but according to the configuration included in the electric storage module 80, it is facilitated to secure the coolant passage as compared with the configuration described in Patent document 1. In addition, in accordance with the electric storage module 80, since the cooling plate 100 absorbs the expansion of the electric storage cells, it is not necessary to separately dispose a structure for absorbing the expansion of the electric storage cells unlike the configurations described in above-mentioned Patent documents 2 and 3.

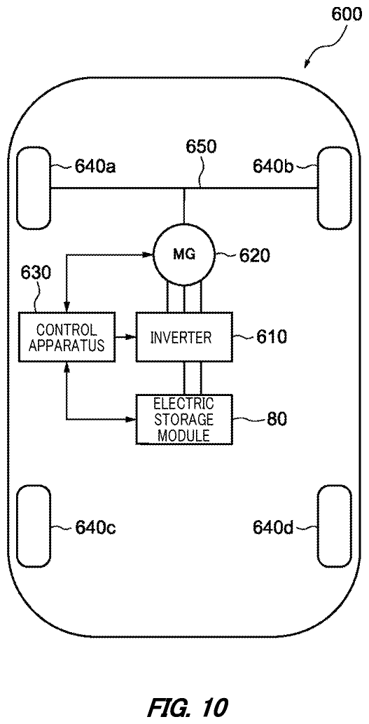

FIG. 10 illustrates a block configuration of a vehicle 600 including the electric storage module 80. The vehicle 600 is, for example, an electric vehicle. The vehicle 600 includes the electric storage module 80, an inverter 610, a control apparatus 630, a motor generator 620, an axle 650, and wheels 640a to 640d. The axle 650 transmits drive force to the wheel 640a and the wheel 640b. An output shaft of the motor generator 620 is coupled to the axle 650 via a torque transmission mechanism.

The motor generator 620 functions as both an electric motor for vehicle drive and an electric generator for regeneration. The electric storage module 80 is configured to supply electrical power to the motor generator 620 by the inverter 610 as a power source of the motor generator 620. At the time of deceleration of the vehicle 600, the motor generator 620 converts deceleration energy into electrical power, and the electric storage module 80 stores regenerated electrical power. The control apparatus 630 is configured to control the motor generator 620, the inverter 610, and the electric storage module 80.

Note that the vehicle 600 is one example of a vehicle including the electric storage module 80. The vehicle may be a hybrid electric vehicle or the like. The vehicle may be a saddle type vehicle.

While the embodiments of the present invention have been described, the technical scope of the present invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 first end plate
20 second end plate
31 side plate
32 side plate
33 intermediate plate
40 electric storage cell
45 terminal
46 terminal
47 laminated film
50 cooling unit
51 opening
52 frame body
53 end portion frame
54 end portion frame
55 side frame
56 side frame
57 recessed portion
58 recessed portion
59 groove portion
60 cell unit
62 frame body
71 screw
72 screw
73 screw
80 electric storage module
82 cell stack
90 insulation plate
110 first plate portion
120 second plate portion
130 internal space
151 protrusion
152 protrusion
153 protrusion
154 protrusion
155 protrusion
156 protrusion
157 protrusion
160 connection portion
161 extension portion
162 extension portion
165 protrusion portion
600 vehicle
610 inverter
620 motor generator
630 control apparatus
640 wheel
650 axle

What is claimed is:

1. A cell cooling body comprising:
a cell housing body housing a plurality of electric storage cells, the cell housing body including a first end plate and a second end plate, and two side plates coupling the first end plate and the second end plate and being placed opposite to each other;
an insulation plate; and
a cooling unit arranged between the plurality of electric storage cells, wherein the cooling unit includes
a cooling plate having a variable thickness, and
a frame body integrated with the cooling plate,
the cooling plate has an internal space and has one or more protrusions protruding towards the internal space.

2. The cell cooling body according to claim 1, wherein the cooling plate includes a connection portion connected to the frame body at both ends of the internal space.

3. The cell cooling body according to claim 1, wherein the cooling plate is configured by two plates, and is joined or is in close contact at both ends of the internal space.

4. The cell cooling body according to claim 1, wherein the cooling plate is integrally molded, and both ends of the internal space are sealed.

5. The cell cooling body according to claim 1, wherein the cooling plate is made of metal.

6. The cell cooling body according to claim 1, wherein:
the cooling plate includes a first plate portion and a second plate portion that face each other in a stack direction of the plurality of electric storage cells; and
the protrusions protrude from at least one of the first plate portion and the second plate portion towards the internal space.

7. The cell cooling body according to claim 6, wherein the protrusions alternately protrude from the first plate portion and the second plate portion towards the internal space.

8. The cell cooling body according to claim 1, wherein the cooling plate has, in both end portions connected to the frame body, an extension portion extending in the internal space in a stack direction of the plurality of electric storage cells.

9. The cell cooling body according to claim 1, further comprising:
an intermediate plate that is arranged in the cell housing body to link the two side plates, the intermediate plate forming a plurality of cell housing spaces with the first end plate and the second end plate.

10. The cell cooling body according to claim 2, wherein the cooling plate is configured by two plates, and is joined or is in close contact at both ends of the internal space.

11. The cell cooling body according to claim 2, wherein the cooling plate is integrally molded, and both ends of the internal space are sealed.

12. The cell cooling body according to claim 2, wherein the cooling plate is made of metal.

13. The cell cooling body according to claim 2, wherein:
the cooling plate includes a first plate portion and a second plate portion that face each other in a stack direction of the plurality of electric storage cells; and
the protrusions protrude from at least one of the first plate portion and the second plate portion towards the internal space.

14. The cell cooling body according to claim 3, wherein:
the cooling plate includes a first plate portion and a second plate portion that face each other in a stack direction of the plurality of electric storage cells; and
the protrusions protrude from at least one of the first plate portion and the second plate portion towards the internal space.

15. The cell cooling body according to claim 4, wherein:
the cooling plate includes a first plate portion and a second plate portion that face each other in a stack direction of the plurality of electric storage cells; and
the protrusions protrude from at least one of the first plate portion and the second plate portion towards the internal space.

16. The cell cooling body according to claim 13, wherein the protrusions alternately protrude from the first plate portion and the second plate portion towards the internal space.

17. The cell cooling body according to claim 2, wherein the cooling plate has, in both end portions connected to the frame body, an extension portion extending in the internal space in a stack direction of the plurality of electric storage cells.

18. The cell cooling body according to claim 2, further comprising:
an intermediate plate that is arranged in the cell housing body to link the two side plates, the intermediate plate forming a plurality of cell housing spaces with the first end plate and the second end plate.

19. An electric storage module comprising:
the cell cooling body according to claim 1; and
the plurality of electric storage cells.

20. A vehicle comprising:
the electric storage module according to claim 19.
